(19) United States
(12) Patent Application Publication
(10) Pub. No.: US 2025/0243881 A1
(43) Pub. Date: Jul. 31, 2025

(54) HYDRAULIC CONTROL SYSTEM FOR COUPLER SAFETY KNUCKLE

(71) Applicant: Cascade Corporation, Fairview, OR (US)

(72) Inventors: Christopher M. Walthers, Gresham, OR (US); Christian Alan James Berg, Portland, OR (US)

(73) Assignee: Cascade Corporation, Fairview, OR (US)

(21) Appl. No.: 18/423,046

(22) Filed: Jan. 25, 2024

(51) Int. Cl. F15B 13/01; B60D 1/28

(52) U.S. Cl. CPC F15B 13/015; B60D 1/28; F15B 2211/30505

(57) ABSTRACT

Hydraulic control circuits, couplers with hydraulic control circuits, and methods for controlling couplers that include a safety knuckle for retaining a first pin and a tongue for retaining a second pin, the safety knuckle automatically resetting upon removal of the safety pin.

### CROSS REFERENCE TO RELATED APPLICATIONS

None

### BACKGROUND

The subject matter of this application relates to couplers for construction equipment, and more specifically to those that have a safety knuckle that prevents inadvertent disengagement of an attachment's safety pin from the coupler.

Oftentimes load-handling construction vehicles, such as excavators and the like, are intended to be coupled to a variety of different attachments (e.g., a bucket), and to facilitate this versatility a coupler is used to securely, but detachably connect the attachment to the vehicle. Typically, these couplers have two opposed pairs of receptacles at an upper interface to retain cylindrical pins on the vehicle, and a pair of receptacles at a lower interface to retain cylindrical pins on the attachment. The upper interface of the coupler is usually intended to connect to the vehicle for an extended period of time, perhaps permanently, but the lower interface of the coupler is usually intended to sequentially connect to a number of different attachments and is therefore designed to quickly and alternately engage with, and disengage from, the pins of any particular one of the attachments.

The lower interface must, however, be capable of doing this reliably and securely so that the attachment does not fall or otherwise move uncontrollably, which could injure someone or damage property. Existing couplers have a lower interface that, as just noted, retains two pins on the attachment. One pin—called a rear pin or back pin—is retained in a rear receptacle by a sliding member that is actuated by a hydraulic actuator, such as a hydraulic cylinder. Another pin—called a front pin or safety pin—is retained in a front receptacle and by a spring-loaded “safety knuckle;” the safety knuckle is free to rotate inwardly, out of the way, as the safety pin slides into the receptacle, but once the pin is clear of the safety knuckle and the safety knuckle returns to its biased position, the knuckle retains the pin in receptacle because the knuckle cannot rotate outwardly from that biased position.

When it is time to release the attachment, the hydraulically actuated sliding member that retains the rear pin can simply be retracted but, as just noted the safety knuckle cannot rotate outwardly to release the safety pin. Instead, another hydraulic actuator is used to rotate it inwardly, moving the safety pin further into the receptacle until the safety knuckle is housed entirely, or nearly entirely within the body of the coupler. This allows the operator to move the coupler and slide the safety pin out of the front receptacle, detaching the attachment from the coupler.

Unfortunately, as just noted, when one attachment is released the safety knuckle is forced to rotate inwardly into the coupler body and needs to be reset in order to able to secure the safety pin of the next attachment to be coupled. Existing implementations usually accomplish this hydraulically by venting fluid to the knuckle's hydraulic actuator when rear receptacle's sliding member is extended to enclose the rear pin of that next attachment. This allows the spring bias of the knuckle to reset the knuckle to the original position. Unfortunately, couplers are configured so that the safety pin must be inserted into the front receptacle first, before the rear pin is inserted into the rear receptacle. This means that the safety pin must not only already be in the front receptacle when the safety knuckle is reset, but it must be far enough in that it does not block the safety knuckle from returning to its biased position. Sometimes this does not occur, and it becomes possible that the rear pin is retained by the coupler, but the safety pin is not because it blocked the safety knuckle from returning to the biased position in which it retained the safety pin.

What is desired, therefore, are improved devices, systems, and methods for resetting the safety knuckle to its biased position after an attachment is released from a coupler.

### BRIEF DESCRIPTION OF THE DRAWINGS

For a better understanding of the invention, and to show how the same may be carried into effect, reference will now be made, by way of example, to the accompanying drawings, in which:

FIG. 1A shows a perspective view of a prior art coupler.

FIG. 1B shows a side view of the coupler of FIG. 1A retaining pins of an attachment.

FIG. 2 shows a prior art hydraulic control circuit for the coupler of FIG. 1.

FIG. 3 shows a coupler with a reset member that ensures that the safety knuckle is reset to its spring-biased position as an inserted safety pin is removed.

FIG. 4 shows a first embodiment of a control circuit for the coupler of FIG. 3.

FIG. 5 shows an alternate embodiment of a control circuit for the coupler of FIG. 3.

### DETAILED DESCRIPTION

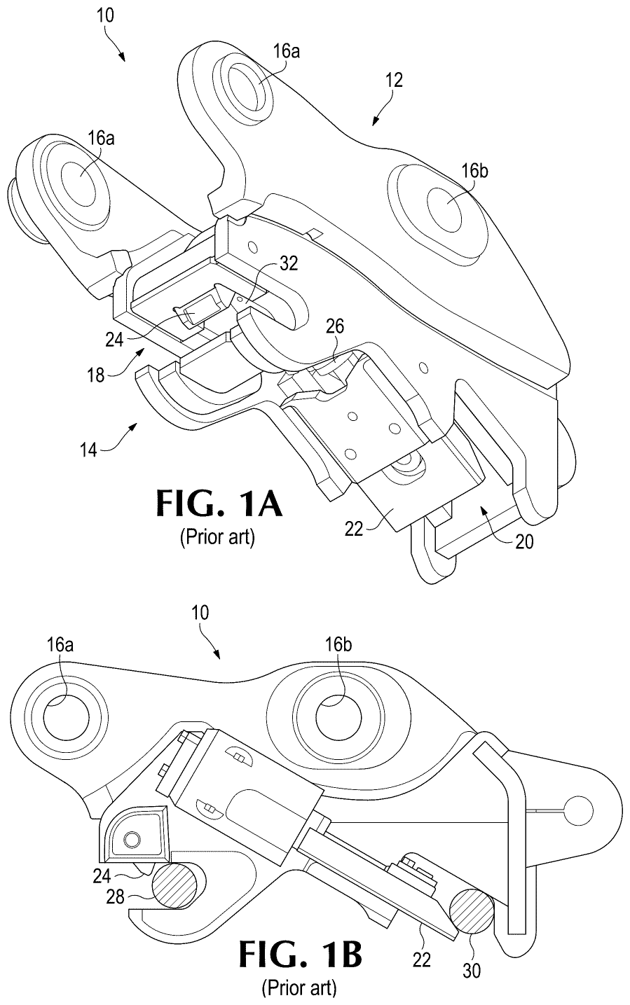

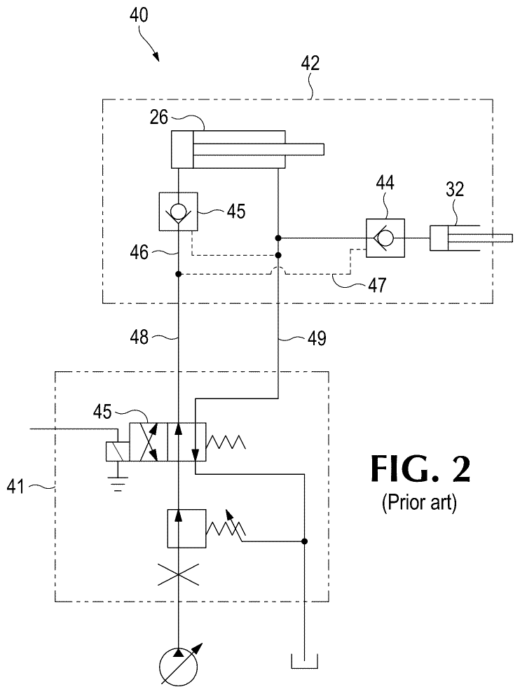

FIGS. 1A and 1B together show an exemplary coupler 10 that is used to detachably couple a construction vehicle to an attachment, which includes an upper interface 12 and a lower interface 14. The upper interface 12 comprises two pairs of openings 16a, 16b, each pair configured as an aperture to receive and retain a pin on a construction vehicle. When retained, the pins on the construction vehicle prevent translation and rotation of the coupler relative to the vehicle. The lower interface 14 comprises a first aperture 18 (called a “hook”) into which a front pin (safety pin) 28 of an attachment may be inserted as well as a second aperture 20 into which a rear pin of an attachment may be inserted. The coupler 10 includes a safety knuckle 24 that, as previously described is spring-biased to the position shown, and can rotate inward from the biased position to allow entry of a safety pin into the first aperture 18, but cannot rotate outward from the biased position, and thus a retained pin 28 is secured within the first aperture 18. The coupler 10 also includes a tongue 22 that extends and retracts to alternately open and close the second aperture 20 so that rear pin 30 of an attachment can be retained or released, as desired.

The coupler 10 also includes a first hydraulic actuator 26 and a second hydraulic actuator 32. The first hydraulic actuator alternately translates the tongue 22 between an extended position as shown in FIGS. 1A and 1B that retains a rear pin 30 of an attachment and a retracted position that allows entry/removal of the rear pin 30 into/from the aperture 20. The second hydraulic actuator 32, conversely rotates the safety knuckle inward to an open position by extending, thus allowing removal of a retained safety pin 28; this is necessary because the safety knuckle cannot rotate outward. When rotated inward, the safety knuckle pushes the safety pin 28 inward into the aperture 18 until the safety knuckle has rotated far enough that it provides clearance for the safety pin to be released from the aperture. The second hydraulic actuator 32 must then be retracted for the spring bias of the knuckle 24 to return it to the retaining or locking position. Thus, although the functions of the two hydraulic actuators 26, 32 are essentially identical, their alternating operations are reversed; the actuator 26 extends to retain a pin while the actuator 32 extends to release a pin, and vice versa.

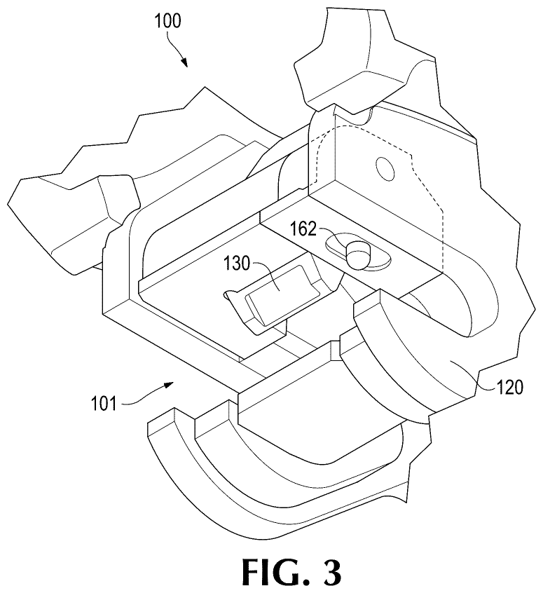

FIG. 2 shows an exemplary prior art control circuit 40 for extending/retracting both the actuator 26 and the actuator 32. The control circuit 40 includes a first, vehicle-side component 41 whose function is to alternately supply pressure from a pump to an extend line 48 of actuator 26 or a retract line 49 of actuator 26. The extend line 48 and retract lines 49 together operate both the actuator 26 and the actuator 32 as described below. The one of the extend line 48 or retract line 49 not connected to the pump is connected to a depressurized tank to allow return flow into the tank from the actuators 26, 32.

To illustrate the operation of this circuit 40, assume that the controlled coupler retains an attachment such that both the safety pin and the rear pin are secured within the apertures 18, 20 of FIGS. 1A, 1B. In this circumstance, the extend line 48 is pressurized and the actuator 26 is extended, while the actuator 32 is retracted such that the safety knuckle 24 is in its biased position, which retains the safety pin 28. To release the attachment, the operator activates solenoid valve 43 which supplies pressure to the retract line 49. This actuates pilot-controlled check valve 45 through pilot line 46, opening pilot-controlled check valve 45 to permit return flow through extend line 48, so that actuator 26 can retract the tongue 22, releasing the rear pin 30. (Pressure supplied to the rod-side of actuator 26 retracts the actuator and fluid is expelled from the head side of that actuator, into the tank.) This also supplies pressurized fluid to the head side of actuator 32, through pilot-controlled check valve 44, which extends the head side of actuator 32, rotating knuckle 24 inward, thus also releasing safety pin 28. The coupler may then be detached from the attachment.

When the coupler 10 is intended to secure another attachment, the procedure is reversed. The coupler is positioned over the new attachment and moved so that the attachment's pins are positioned in their respective apertures. The operator activates solenoid 43 to supply pressure to extend line 48, which extends actuator 26 (and tongue 22) to lock the rear pin into place; simultaneously pilot line 47 opens pilot-controlled check valve 44, which releases pressurized fluid trapped in actuator 32 and allows it to return to the tank. This permits the spring-loaded safety knuckle to return to its locking position, securing the safety pin of the new attachment to the coupler 10.

Unfortunately, the control circuit 40 may not always work as intended, and the safety pin 28 may not be properly secured into aperture 18. Thus, if the control circuit loses pressure, for example, the coupler could lose control over the attachment. Specifically, couplers such as coupler 10 are configured so that the safety pin must be inserted into aperture 18 (the hook) first, then the coupler is rotated downward to contact the rear pin, and the rear pin secured by extending the tongue. The coupler 10 cannot be attached by first securing the rear pin with the tongue, by extending the actuator 26, and then inserting the safety pin into the hook to clear an already-reset safety knuckle. Thus, as can be seen in FIG. 1B, the safety pin 28 can only be inserted into the aperture 18 (the hook) while the safety knuckle is retracted by the actuator 32, because the safety knuckle can only return to its biased (default position) by the same operation that extends the tongue to secure rear pin, which again as just noted cannot physically happen until after the safety pin is in place.

This means, given the clearance or size of the front aperture 20, it is possible that when the tongue 22 is extended, the safety pin already inserted into the hook blocks the safety knuckle from returning to its biased position, and the safety pin is then on the wrong side of the safety knuckle. So long as the tongue retains the rear pin, the front or safety pin will still be retained in its slot, but should something happen to dislodge the rear pin, the safety pin will not operate as intended and the attachment may inadvertently be released, causing injury or property damage.

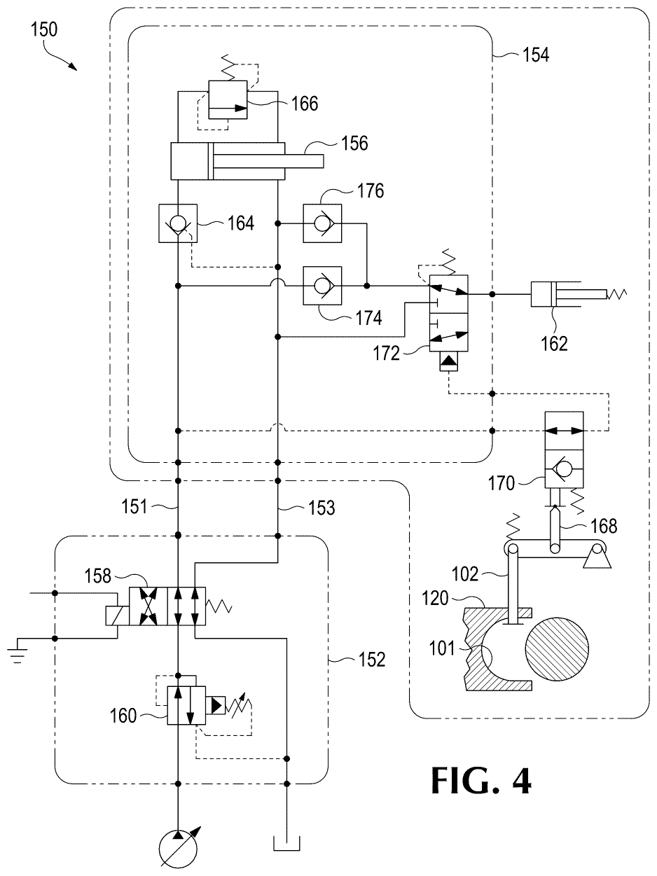

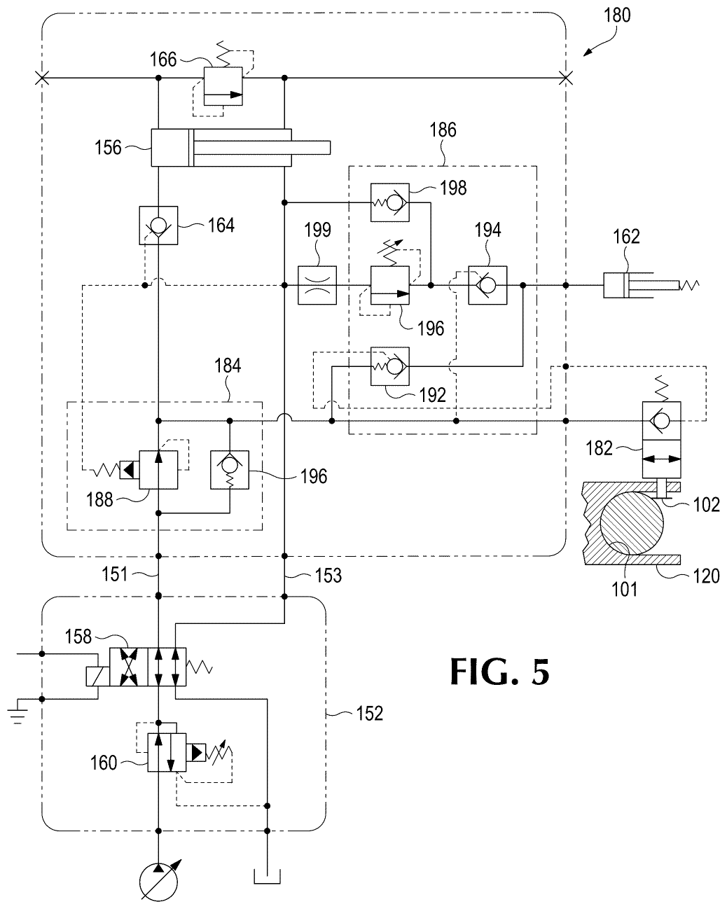

FIG. 3 shows a partial perspective view of an improved coupler 100 having a hook portion 120 capable of automatically resetting safety knuckle 130 whenever a safety pin, previously locked within the hook, is removed from aperture 101. Thus, safety knuckle 130 will always be in its default, biased position when coupling to a new attachment because the act of detaching the safety pin of the previous attachment itself resets the safety knuckle, eliminating the need to wait for the tongue of coupler to extend and secure the rear pin to the coupler. This functionality is achieved, in conjunction with control circuitry exemplified by FIG. 4, by a trigger 102 mounted in the aperture 101 that activates when a safety pin is removed, and when a safety pin is inserted.

Specifically, FIG. 4 shows a hydraulic control circuit 150 that controls actuator 156 and actuator 162. Like the circuit of 40 of FIG. 2, the actuator 156 drives a tongue to selectively lock and release a rear pin while actuator 162 acts to retract safety knuckle 130 to selectively release a safety pin. Also, like the circuit 40 of FIG. 2, the control circuit 150 includes a vehicle-side component 152 by which an operator may actuate a solenoid valve 158 to alternately connect either one of an extend line 151 or a retract line 153 to a pump to pressurize one of the lines 151, 153 while allowing the other line to return fluid to an unpressurized tank or reservoir. The component 152 may also optionally include a pressure-reducing valve 160 that limits the supplied pressure to a maximum value.

The operation of the circuit 150 can be readily understood by first assuming that a coupler 100 is approaching an attachment to be secured therein, and in this initial state the cylinder 156 and 162 are both retracted as shown, the safety knuckle is in its default, biased position, and pressure is supplied to retract line 153, which holds cylinder 156 in its retracted position i.e., solenoid valve 158 is activated. This condition may occur, for example, when the coupler 100 is first used. At this time, assume that the coupler 100 approaches an attachment and its safety pin rides into the aperture (hook) 101, moving the safety knuckle out of its way momentarily before the knuckle returns to its “safety” position due to its spring bias (the cylinder 162 starting from a retracted position). This moves the trigger 102 upwards, which also raises plunger 168 of two-way valve 170 from a bidirectional state to a unidirectional state (a check valve), which now allows pilot pressure to be supplied to another two way valve 172, whose operation will be described shortly. In this position, the valve 170 does not allow that pilot pressure to be relieved, essentially trapping the pilot pressure and locking the two-way valve 172 into its actuated state. The safety pin now secured, the operator then continues to engage the coupler 100 with the attachment by lowering it over the rear pin to a position that is ready to engage the rear pin.

At this time, an operator may deactivate solenoid valve 158, which causes extend line 151 to be pressurized. Fluid flows through pilot-controlled check valve 164 and into the head-side of cylinder 156, extending it and also extending the tongue to secure the rear pin into place. Fluid expelled from the cylinder 156 returns to tank from the retract line 153. The coupled attachment is now ready to be used. Those of ordinary skill in the art will recognize that the circuit 150 may or may not include optional pressure relief valve 166 that protects the hydraulic circuit from damage due to overpressure to the cylinder 156, which may occur for example, if the attachment pushes against something in a manner that tends to retract the cylinder 156 while its head side is pressurized.

When it is time to decouple the attachment from the coupler 100, the operator may then activate solenoid valve 158 to supply pressure to the retract line 153. This retracts cylinder 156 and its associated tongue, which releases the rear pin and also—because the valve 172 has been locked into the actuated position by the trapped pressure in its pilot line—extends the cylinder 162 and retracts the safety knuckle into the coupler 100, thereby allowing the safety pin to be removed. Notably, when the safety pin is removed, the trigger 102 descends to thereby connect the pilot line of two-position valve 172 to the tank, releasing the trapped pressure in the pilot line. The two-position valve 172 then resumes its normal position, and the fluid at the head side of the cylinder 162 is released to tank through check valve 174. The spring-loaded knuckle then resets to its spring-loaded position.

As can therefore be appreciated, the trigger 102, in combination with the two-position valves 170 and 172 causes the safety knuckle to automatically reset whenever the safety pin of an attachment is removed from the hook of a coupler, even when the cylinder 162 is extended, and without having to first close the tongue of the coupler to engage the rear pin. This substantially improves the safety of a coupler that includes these features.

Those of ordinary skill in the art will appreciate that the control circuit 150 may preferably include check valve 170, which vents the spring chamber of valve 172 and working port to the retract line 153 during ordinary use, ensuring that valve 172 is in the shifted state whenever a coupler is being used.

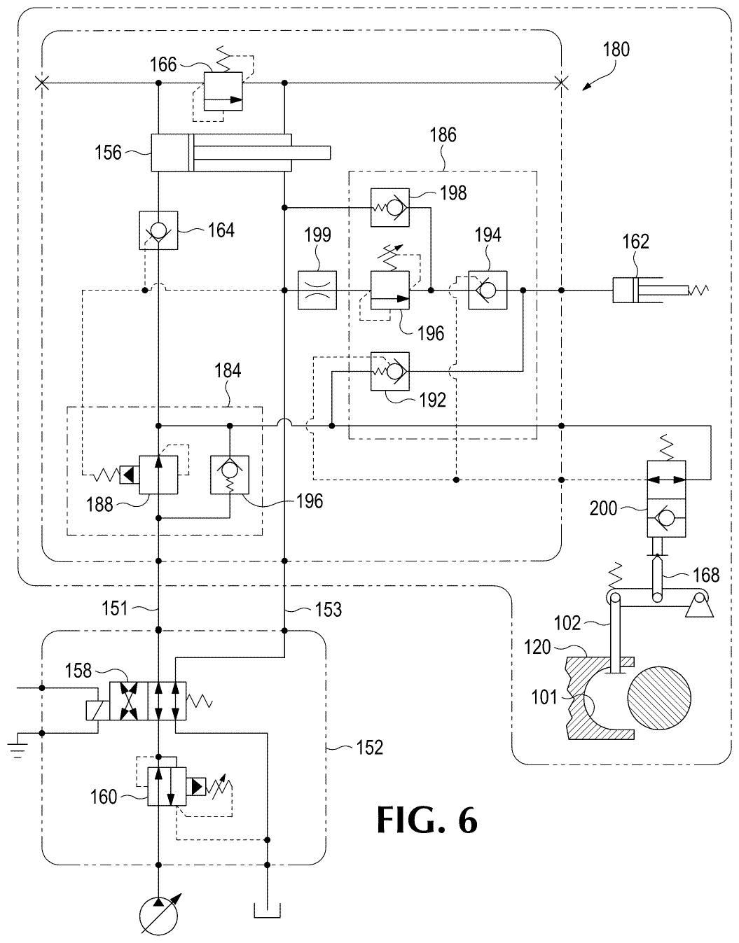

FIG. 5 shows an alternate hydraulic control circuit 180 for the operation of the actuators 156 and 162 that includes several improvements over the control circuit 150 of FIG. 4. First, the hydraulic control circuit 180 includes a first valve arrangement 184 that reduces the head side pressure supplied to hydraulic actuator 156 during extension relative to the rod side pressure supplied to it during retraction. This has the benefit of preventing the hydraulic actuator 156 from sticking during retraction—a condition that otherwise might occur since the rod-side area of the actuator is typically less than the head-side area. Second, the hydraulic control circuit 180 includes a second valve arrangement 186 that the reduces the pressure supplied to the hydraulic actuator 162 relative to that supplied to actuator 156 while the latter is being retracted (and the actuator 162 extended to retract the safety knuckle). This achieves two benefits. First, it provides a sequencing of the operation of the two hydraulic actuators 156 and 162 i.e., the amount of pressure reduction in second valve arrangement 186 is set so that the hydraulic actuator 156 causes the tongue to fully retract before the safety knuckle is retracted, which is a safer sequence of operation because otherwise the attachment could be suddenly decoupled by maintaining engagement with the front pin for a longer period of time. Second, it permits the use of lower-pressure components in the control circuit 180 used to extend/retract the hydraulic actuator 162, and more specifically allows the use of poppet valves for this function. Poppet valves exhibit less leakage than other valve types, and such leakage could inadvertently close the valves too soon and the safety pin would not be able to be disconnected. Thus, the use of poppet valves reduces the likelihood of such an event occurring. Third, the second valve arrangement 186 preferably includes a combination of pilot-to-open check valves and pilot-to-close check valves that together provide the same trigger functionality as that was described with respect to FIG. 4 i.e., the combination of pilot-controlled valves causes the safety knuckle of a coupler to automatically reset whenever the safety pin of an attachment is removed from the hook of that coupler, even when the cylinder 162 is extended, and without having to first close the tongue of the coupler to engage the rear pin.

These benefits can be easily seen in reference to the operation of the circuit 180 of FIG. 5. Again, assuming that a coupler 100 is approaching an attachment to be secured therein, and in this initial state the cylinder 156 and 162 are both retracted as shown, the safety knuckle is in its default, biased position, and pressure is supplied to retract line 153, which holds cylinder 156 in its retracted position i.e., solenoid valve 158 is activated. This condition may occur, for example, when the coupler 100 is first used. At this time, assume that the coupler 100 approaches an attachment and its safety pin rides into the aperture (hook) 101, moving the safety knuckle out of its way momentarily before the knuckle returns to its “safety” position due to its spring bias (the cylinder starting from a retracted position). This moves the trigger 102 upwards, briefly, as the safety pin passes the trigger 102 on its way to a seated position in the hook 120. This activates two-way valve 182 to switch from a default check valve position (described later) to a bidirectional position that relieves pilot pressure to a pilot-to close check valve 192. The pilot-to-close check valve 192 is one where flow is always prevented in one direction through the valve, but when pilot pressure is supplied, flow is blocked in the other direction as well. Thus, as can be seen in FIG. 5, when the two-way valve 182 is momentarily activated to allow bidirectional flow through it at this time, nothing happens; even if pilot pressure had previously been supplied, hydraulic actuator 162 was already in its retracted state and exposing it to the tank pressure in extend line 151 has no effect.

The safety pin now secured, the operator continues to engage the coupler 100 with the attachment by lowering it over the rear pin to a position that is ready to engage the rear pin. Once the rear pin is engaged, the operator can deactivate solenoid 158, which now supplies pump pressure to extend line 151 and connects the retract line 153 to tank. Flow then passes through first valve arrangement 184, which preferably includes a pressure reducing valve 188, which in this embodiment limits the supplied pressure in the portion of the extend line 151 beyond the valve 188. This limit is less than the maximum pressure that can be supplied by the pump though retract line 153. In one embodiment, the pressure reducing valve 188 is limited to a pressure to ensure that the force applied to the rod-side of actuator 156 during its retraction is equal to or greater than the force applied to its head side during extension. As noted above, this inhibits sticking that might occur when actuator 156 is to be retracted.

Also, while the actuator 156 is being extended due to pump pressure being supplied to extend line 151, that pressure is used to supply pressure to the pilot port of pilot-to-open check valve (POC) 194. Pilot-to-open check valve 194 is one where the check valve always allows unidirectional flow from the retract line 153 into the hydraulic actuator 162, but when piloted allows bidirectional flow such that fluid may flow from actuator 156 back into the retract line 153. Thus, when hydraulic actuator 156 is being extended, to lock the rear pin of an attachment into the coupler, any pressure that might have otherwise kept actuator 156 extended will be exhausted through check valve 194, on through check valve 198, and into retract line 153, ensuring that the safety knuckle is in place to prevent the safety pin from detaching from the coupler while the rear pin is being engaged.

While the actuator 156 is being extended due to pump pressure being supplied to extend line 151, that pressure is also used to supply pressure to the pilot port of pilot-to-close check valve (PCC) 192. As noted earlier, pilot-to-close check valve 192 is one where the check valve always blocks flow from the extend line 151 into the hydraulic actuator 162, but only when piloted, also blocks fluid flowing from the actuator 162 back into the extend line 151. When extend line pressure is supplied to the pilot port of PCC 192, that pilot pressure will be trapped by two-way valve 182 as long as it is in its default position i.e., when the safety pin is seated in the coupler.

When it is time to decouple the attachment from the coupler 100, the operator may then activate solenoid valve 158 to supply pressure to the retract line 153. This retracts cylinder 156 and its associated tongue, which releases the rear pin and also—because the valve 182 remains in its normal, default position that maintains pressure to the pilot port of PCC 192, actuator 162 is isolated from the extend line 151 (now at tank pressure), which allows fluid in the retract line 153 to also extend actuator 162, which retracts the safety knuckle into the coupler body, freeing the safety pin to be removed. Notably, when the safety pin is removed, it must momentarily activate pin 102, which vents the pilot pressure to PCC valve 192. This now allows any pressure that had previously extended actuator 162 to exhaust to the tank, automatically resetting the safety knuckle to its safety position. Thus, just as with respect to the embodiment of FIG. 4, the trigger 102 in combination with the second valve arrangement 186 and its associated pilot-operated check valves, causes the safety knuckle to automatically reset whenever the safety pin of an attachment is removed from the hook of a coupler, even when the cylinder 162 is extended, and without having to first close the tongue of the coupler to engage the rear pin. This substantially improves the safety of a coupler that includes these features.

The PCC valve 192 and the POC valve 194 are in some embodiments preferably poppet valves. As noted earlier, poppet valves beneficially reduce leakage relative to other valves. Thus, because POC poppet valve 194 and PCC poppet valve 192 are used to supply fluid to, and receive pressure from, the hydraulic actuator 162, respectively, this means that its operation is less likely to malfunction by for example, closing the valves too soon and inadvertently releasing the safety pin or preventing its retraction.

As also noted above, the second valve arrangement 186 also preferably ensures proper sequencing of the operations of actuators 156 and 162, such that actuator 156 begins to extend before actuator 162 does, and more preferably may release the rear pin before releasing the safety pin. In still a further preferred embodiment, the second valve assembly is configured to fully release the rear pin before the front pin begins to be released.

In a preferred embodiment, this sequencing is achieved by reducing the pressure supplied to the hydraulic cylinder 162 relative to the pressure supplied to actuator 156 while it extends. This is typically preferential to other mechanisms that might provide such sequencing. For example, the actuator 162 could be decreased in size so that more pressure is needed at its head side in order to extend it, relative to the rod-side of actuator 156, but it is generally preferred to reduce the size or footprint of the actuator 162 in the coupler 100, not increase it. As also noted above, achieving sequencing by a pressure reduction to actuator 162 may in some embodiments (e.g., when pump pressure needed to retract actuator 156 is relatively high) permit the use of poppet valves in second valve assembly 186 where they otherwise could not be used. In the embodiment shown in FIG. 5, the desired pressure reduction is achieved by pressure relief valve 196, which requires that the pressure at its input port do work on a spring, and this work applies a pressure differential across it by an amount determined by the resistance of the spring.

Hydraulic control circuit 180 also includes a number of other features. For example, in preferred embodiments, circuit 180 includes check valve 190 that allows fluid returning to the pump through extend line 151 to bypass pressure reducing valve 188. Hydraulic control circuit 180 also preferably includes an orifice 199 that regulates the flow from retract line 153 into hydraulic actuator 162. This is because in the embodiment of FIG. 5, when retract line 153 is pressurized there is a brief short circuit for fluid to flow out of retract line 153, through the pilot check valves 192 and 194, and out through the extend line 151 after two-way valve 182 is activated. The orifice limits the amount of flow though this short-circuit path.

Those of ordinary skill in the art may also note that the embodiment of FIG. 4 differs from that of FIG. 5 in that the latter embodiment is intended to trigger or guarantee the reset of the safety knuckle only as the safety pin passes by the trigger (plunger) 102 while it is intentionally removed, but when fully seated in the hook, the safety pin is not intended to trigger the reset. Were the reset to be triggered while the safety pin was secured in the coupler and when pressure was applied to the extend line when the tongue were being closed, say by the operator moving the coupler, pressure to the pilot port of PCC 192 might be inadvertently allowed to vent when it intended to be trapped in the pilot port. This in turn might prevent the safety knuckle from being extended out of the way when the retract line 153 is pressurized due to a short circuit through PCC 192, preventing the safety pin from being removed. This issue can easily be avoided by positioning the safety knuckle to prevent any displacement of the safety pin from its seated position until such time as the actuator 162 is intentionally extended to retract the safety knuckle.

Furthermore, the hydraulic circuit 180 may easily be used with a coupler having a safety pin intended to be seated in a position that always activates the trigger 102, similar to what is shown in FIG. 4. This alternate embodiment is shown in FIG. 6, and is can be quickly confirmed that the circuit 180 of FIG. 6 is identical to that of FIG. 5; the difference in these figures is entirely in manner in which the plunger 102 of the hook 120 interacts with the two way valve 200 of FIG. 6. In this latter figure, the two-way valve is reversed relative to the valve 182 of FIG. 5 i.e., the default or biased position is one where the two-way valve allows bidirectional flow, and when the trigger 102 is activated by the safety pin the two way valve switches to unidirectional flow. This ensures that when the safety pin is seated in the coupler, pressure supplied to the actuator 156 to extend the tongue will always trap pressure to the pilot port of PCC valve 192. Conversely, that pilot pressure will only be released (resetting the safety knuckle) after the tongue has begun to retract and also after the safety pin is intentionally removed.

Those of ordinary skill in the art will appreciate that in preferred embodiments the hydraulic actuators 156 and 162 may preferably be hydraulic cylinders, but other embodiments may use other types of actuators, such as a rotary actuator. Similarly, though FIGS. 4-6 show embodiments where extend line 151 is pressurized when solenoid valve 158 is not actuated, and retract line 153 is pressurized when solenoid valve 158 is actuated, other embodiments may reverse this configuration. Moreover, those of ordinary skill in the art will appreciate that the two-position solenoid valve 158 may be replaced with a three-position valve having an intermediate position where neither the extend line nor the retract line is pressurized.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A hydraulic control circuit for a coupler intended to connect a vehicle to an attachment, the coupler intended to receive a rear pin selectively retained and released by operation of a first hydraulic actuator and a front pin selectively retained and released by a safety knuckle by operation of a second hydraulic actuator, the hydraulic control circuit comprising a valve assembly that sequences the first hydraulic actuator to begin to release the rear pin prior to beginning to release the front pin.

2. The hydraulic control circuit of claim 1 where the valve assembly includes at least one poppet valve.

3. The hydraulic control circuit of claim 1 where the valve assembly includes at least one pilot-controlled check valve.

4. The hydraulic control circuit of claim 3 where the at least one pilot controlled check valve includes a poppet valve.

5. The hydraulic control circuit of claim 3 where at least one pilot controlled check valve includes a pilot-to-open check valve.

6. The hydraulic control circuit of claim 3 where at least one pilot controlled check valve includes a pilot-to-close check valve.

7. The hydraulic control circuit of claim 1, sequencing resulting from at least one valve that reduces pressure to the second hydraulic actuator.

8. The hydraulic control circuit of claim 1 where the valve assembly triggers a reset of the safety knuckle as the front pin is removed from the coupler.

9. A hydraulic control circuit for a coupler intended to connect a vehicle to an attachment, the coupler intended to receive a rear pin selectively retained and released by operation of a first hydraulic actuator and a front pin selectively retained and released by a safety knuckle by operation of a second hydraulic actuator, the hydraulic control circuit comprising a valve assembly that triggers a reset of the safety knuckle to a default position as the front pin is removed from the coupler, the valve assembly including at least one poppet valve.

10. The hydraulic control circuit of claim 1 where the valve assembly includes at least one pilot-controlled check valve.

11. The hydraulic control circuit of claim 10 where at least one pilot controlled check valve includes a pilot-to-open check valve.

12. The hydraulic control circuit of claim 10 where at least one pilot controlled check valve includes a pilot-to-close check valve.

13. A hydraulic control circuit for a coupler intended to connect a vehicle to an attachment, the coupler intended to receive a rear pin selectively retained and released by operation of a first hydraulic actuator and a front pin selectively retained and released by a safety knuckle by operation of a second hydraulic actuator, the hydraulic control circuit comprising a valve assembly that includes a plurality of pilot-controlled check valves that together trigger a reset of the safety knuckle to a default position as the front pin is removed from the coupler.

14. The hydraulic control circuit of claim 13 where the valve assembly includes at least one poppet valve.

15. The hydraulic control circuit of claim 13 where the valve assembly includes at least one a pilot-to-open check valve.

16. The hydraulic control circuit of claim 13 where at least one pilot-controlled check valve includes a pilot-to-close check valve.

17. The hydraulic control circuit of claim 13, where the valve assembly sequences the first hydraulic actuator to begin to release the rear pin prior to beginning to release the front pin.

18. The hydraulic circuit of claim 17, sequencing resulting from at least one valve that reduces pressure to the second hydraulic actuator.
